(19) United States
(12) Patent Application Publication
(10) Pub. No.: US 2017/0223000 A1
(43) Pub. Date: Aug. 3, 2017

(54) LOGIN CONTROL METHOD, APPARATUS, AND COMPUTER-READABLE RECORDING MEDIUM

(71) Applicant: FUJITSU LIMITED, Kawasaki-shi (JP)

(72) Inventor: Katsuhiro Yoda, Kodaira (JP)

(73) Assignee: FUJITSU LIMITED, Kawasaki-shi (JP)

(21) Appl. No.: 15/403,031

(22) Filed: Jan. 10, 2017

(30) Foreign Application Priority Data
Feb. 2, 2016 (JP) 2016-018236

(51) Int. Cl. H04L 29/06

(52) U.S. Cl. CPC H04L 63/08

(57) ABSTRACT

A login control method is executed by a computer. The login control method includes inputting a serial signal that corresponds to ON-operations and OFF-operations; measuring respective ON-times of the ON-operations and respective OFF-times of the OFF-operations of the input serial signal; referring to a storage unit, which stores average times for the respective ON-times, deviations for the respective ON-times, average times for the respective OFF-times, and deviations for the respective OFF-times, to determine whether the measured respective ON-times and the measured respective OFF-times are within permissible ranges; and permitting login in a case where the measured respective ON-times and the measured respective OFF-times are within the permissible ranges.

### CROSS-REFERENCE TO RELATED APPLICATION

This application is based upon and claims the benefit of priority of the prior Japanese Patent Application No. 2016-018236, filed on Feb. 2, 2016, the entire contents of which are incorporated herein by reference.

### FIELD

The embodiments discussed herein relate to a login control method, a login control apparatus, and a computer-readable recording medium.

### BACKGROUND

The development of wearable devices has become active. It is important for a small terminal apparatus such as a wearable device, for example, to be fitted comfortably and to prolong duration of continuous use. Thus, size reduction and electric power savings are required. Small-scale terminal apparatuses due to their small size have a physically limited User Interface (UI) because the apparatus is small. However, because important information such as biometric information, for example, is stored in the small terminal apparatus in many cases, it is essential for the small terminal apparatus to manage security for the important information.

Accordingly, in a smartphone or the like, a user inputs a login password while viewing the screen. When the authentication is successful, the lock of the terminal apparatus (smartphone) is released. However, because of the request for size reduction, the wearable device does not have a display screen in some cases. There are cases in which the login password cannot be input from the screen.

An authentication apparatus that uses a switch to determine a password is known in the related art (for example, see Patent Document 1). An information processing apparatus, which releases a lock state in a case where a tap operation of a predetermined pattern is performed with respect to a code rhythm pattern corresponding to reference tap intervals that represent timings of the tap operation, is known in the related art (for example, see Patent Document 2).

The apparatus disclosed in Patent Document 2 presets a fixed value to a margin range for the reference tap interval, and in a case where deviation of the timing of the tap operation is within the predetermined margin range from the reference tap timing, the apparatus determines that the code rhythm pattern is input in the correct timing.

However, even when a user intends to perform a switch operation or a tap operation for beating a same rhythm, the rhythm of the operation may change depending on user state of mind at that time, a surrounding environment, physical condition of the user, or the like in a case where the user is listening to a fast tempo music or a case where the user is sleepy, for example. As a result, when the switch operation or the like performed for the login is measured by a login control apparatus, there may be cases where the operated rhythm is deviated from the predetermined margin range.

Further, if the predetermined operation rhythm is stolen (imitated) and the user is impersonated by another person, a problem may occur whereby said another person can login to the apparatus.

### RELATED-ART DOCUMENTS

### Patent Documents

[Patent Document 1] Japanese Laid-open Patent Publication No. 2004-280562
[Patent Document 2] Japanese Laid-open Patent Publication No. 2013-74432
[Patent Document 3] Japanese Laid-open Patent Publication No. 2005-222411
[Patent Document 4] Japanese Laid-open Patent Publication No. 2007-235867

### SUMMARY

According to an aspect of the embodiments, a login control method executed by a computer includes inputting a serial signal that corresponds to ON-operations and OFF-operations; measuring respective ON-times of the ON-operations and respective OFF-times of the OFF-operations of the input serial signal; referring to a storage unit, which stores average times for the respective ON-times, deviations for the respective ON-times, average times for the respective OFF-times, and deviations for the respective OFF-times, to determine whether the measured respective ON-times and the measured respective OFF-times are within permissible ranges; and permitting login in a case where the measured respective ON-times and the measured respective OFF-times are within the permissible ranges.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIGS. 1A and 1B are diagrams that describe deviations in operation timings with respect to an input operation;

FIGS. 2A to 2D are diagrams each of which illustrates an example of an entire structure of a wearable device according to one embodiment;

FIG. 3 is a diagram illustrating an example of a hardware structure of the wearable device according to one embodiment;

FIG. 4 is a diagram illustrating an example of a functional structure of the wearable device according to one embodiment;

FIG. 5 is a table illustrating an example of an operation information registration DB according to one embodiment;

FIG. 6 is a flowchart illustrating an example of login control processing according to a first embodiment;

FIG. 7 is a diagram illustrating a login control operation according to the first embodiment;

FIG. 8 is a table illustrating an example of results of the login control processing according to the first embodiment;

FIG. 9 is a flowchart illustrating an example of login control processing according to a second embodiment;

FIG. 10 is a diagram illustrating a login control operation according to the second embodiment;

FIG. 11 is a flowchart illustrating an example of login control processing according to a third embodiment;

FIGS. 12A and 12B are tables illustrating an example of an operation information registration DB according to a fourth embodiment;

FIG. 13 is a flowchart illustrating an example of login control processing according to the fourth embodiment; and

FIG. 14 is a table illustrating an example of results of the login control processing according to the fourth embodiment.

### DESCRIPTION OF EMBODIMENT

In the following, embodiments of the present invention will be described with reference to the accompanying drawings. It should be noted that, in the following descriptions and drawings, the same reference numbers are given to elements having substantially the same functions such that overlapping descriptions may be omitted as appropriate.

(Problem Relating to Deviation of Operation Timing)

Login authentication may be performed by comparing a login operation, which a user performs, with a reference that is a previously registered password. The login operation of the user is performed by touching one or more buttons, one or more switches, one or more keys, and/or a screen. Times (time spans) of the login operation of the user during which the button or the like is pushed and times (time spans) of the login operation of the user during which the button or the like is released are compared with the reference to perform the login authentication.

In the following, an operation (manipulation) performed by pushing a button or the like is referred to as an “ON-operation”, and an operation (manipulation) performed by releasing the button or the like is referred to as an “OFF-operation”. Further, a time (time span) during which the button or the like is being pushed by a user's finger is referred to as an “ON-time” and a time (time period) during which the user's finger is released from the button or the like is referred to as an “OFF-time”. In other words, the button is not pushed by the user's finger during the OFF-time.

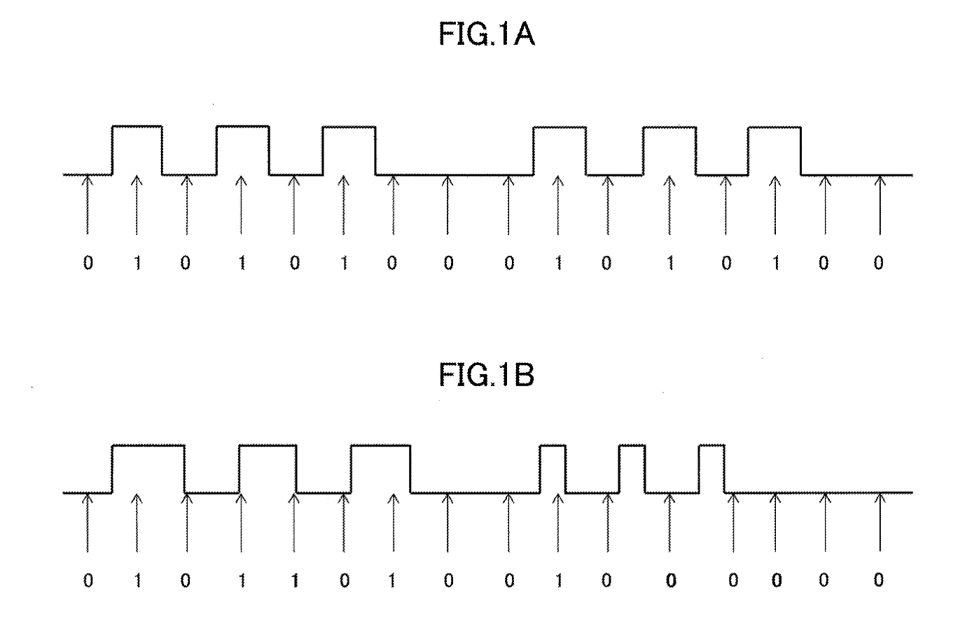

FIG. 1A illustrates an example of a pattern of operation timings of ON-operations and OFF-operations used for login authentication. The pattern of the operation timings used for the login authentication is registered in a data base (DB) in advance. That is, the pattern of the operation timings of the ON-operations and the OFF-operations illustrated in FIG. 1A is an example of a registered password. In the following, the pattern may be referred to as a “serial signal”.

In the login operation of the serial signal, when a tempo (pace) becomes a little faster in the middle of the operation, a login control apparatus recognizes the change even if a user intends to input (enter) an initial part of the pattern according to the operation timings of FIG. 1A that have been registered in advance. As a result, the login control apparatus determines that the input login operation is different from the operation timings that the registered password represents and does not permit the login.

For example, in the login operation of the user as illustrated in FIG. 1B, timing of the first ON-operation is deviated from the timing of the first ON-operation illustrated in FIG. 1A, and the timings of the subsequent ON-operations and OFF-operations are deviated. In this way, in particular, in a case where the deviation (disagreement) of the operation rhythm (tempo) occurs in a first half of the login operation, a problem occurs, from a standpoint of absolute time with respect to a starting point of the login operation, that deviations are accumulated in the latter half of the login operation and the login operation becomes dramatically different from the registered password that is the reference.

As for the above described problem, the accuracy of login authentication can be enhanced by using particularities (characteristics) of each user that occur at the time of operation with respect to the rhythmic pattern of a same registered password and by learning the particularities of each user. In the following, a login control apparatus that can perform login control in accordance with a rhythm (rhythmic pattern) of a login operation of each user will be described.

[Entire Structure of Wearable Device 10]

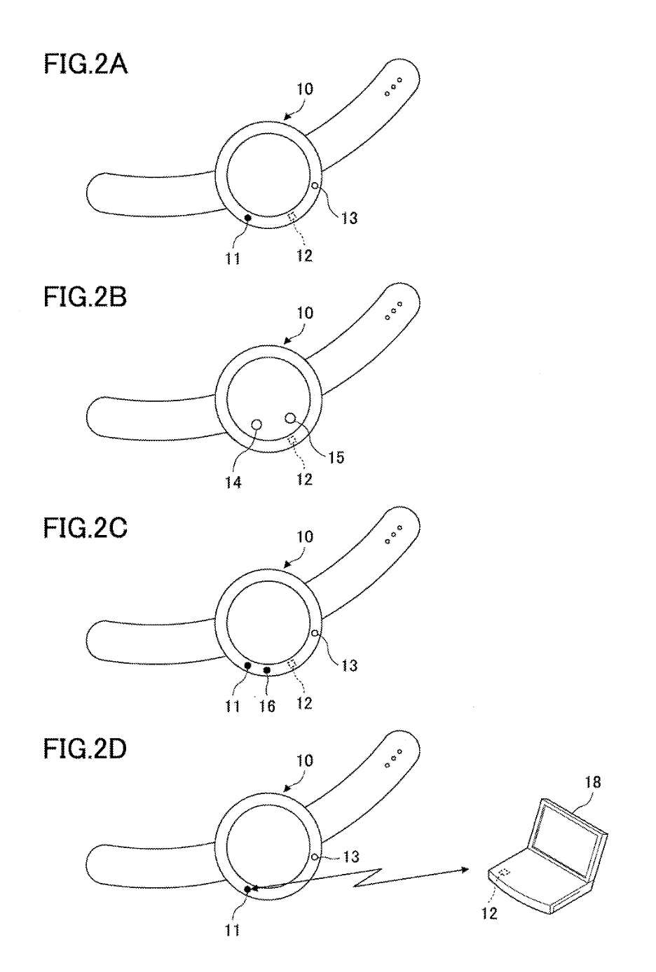

First, examples of an entire structure of a wearable device 10 according to one embodiment of the present invention will be described with reference to FIGS. 2A to 2D. In the embodiment, a wristwatch-type wearable device 10 is described as an example of a login control apparatus. However, the wearable device 10 according to the embodiment is not limited to the wristwatch-type device. For example, the wearable device 10 may be a wearable terminal device such as a Head Mounted Display or a Face Mounted Display.

Further, the wearable device 10 according to the embodiment is not limited to a wearable terminal device. The wearable device 10 may be a Personal Computer (PC), a smartphone, a Personal Digital Assistant (PDA), a portable phone, or the like. Further, the wearable device 10 may be any electronic device that performs a login operation such as a game device, a video camera, a digital camera, a portable image (video) processing device, or a portable music reproducing device.

Each of FIGS. 2A to 2D illustrates an example of the wearable device 10 according to the embodiment. The wearable device 10 illustrated in FIG. 2A includes a button 11, a LED 13, and a login controlling circuit 12. The login controlling circuit 12 is built in the wearable device 10. The button 11 is a mechanical button. The button 11 may be a switch. A user pushes the button 11 to perform an “ON-operation”. The user releases the button 11 to perform an “OFF-operation”. In other words, for example, the wearable device 10 detects that the ON-operation is performed when the button 11 is pushed (touched) by a user's finger or the like, and detects that the OFF-operation is performed when the user's finger or the like is separated from the button 11. The user performs ON-operations and OFF-operations in a predetermined rhythm (pace) to generate a serial signal that represents a password. The login controlling circuit 12 inputs the serial signal that corresponds to the operations of the button 11 by the user, and performs login authentication. The LED 13 is an example of a light source. For example, the LED 13 is lit up when outputting a warning or the like.

Each of FIGS. 2B to 2D illustrates a variation example of the wearable device 10 of FIG. 2A. The wearable device 10 illustrated in FIG. 2B includes a display button 14 and a display lamp 15. The login controlling circuit 12 is built in the wearable device 10. The display button 14 is a softkey (software button). The display button 14 can detect a touch operation applied to the display button 14. With the user performing the touch operation of the display button 14 as the ON-operation and an operation of releasing the touch of the display button 14 as the OFF-operation, the user inputs the serial signal. The display lamp 15 changes display color when outputting a warning or the like.

The wearable device 10 illustrated in FIG. 2C includes a plurality of buttons 11 and 16, and a plurality of LEDs 13. The login controlling circuit 12 is built in the wearable device 10. The user can input one serial signal by performing ON-operations and OFF-operations on the button 11. Further, the user can input another serial signal by performing the ON-operations and the OFF-operations on the button 16. One login ID can be given to the serial signal that uses the button 11. Another login ID can be given to the serial signal that uses the button 16.

The wearable device 10 illustrated in FIG. 2D includes the button 11 and the LED 13. However, the login controlling circuit 12 is not built in the wearable device 10. The login controlling circuit is built in an information processing apparatus that can establish communication with the wearable device 10. The information processing apparatus 18 may be a PC or the like. The serial signal generated by the user operation is transmitted to the information processing apparatus through wireless connection (radio). The information processing apparatus 18 performs the login authentication by use of the internal login controlling circuit 12. In a case of permitting the login, the information processing apparatus 18 transmits, to the wearable device 10, a signal for releasing a lock of the wearable device 10. In a case of not permitting the login, the information processing apparatus 18 transmits, to the wearable device 10, a signal for locking the wearable device 10.

[Hardware Structure of Wearable Device 10]

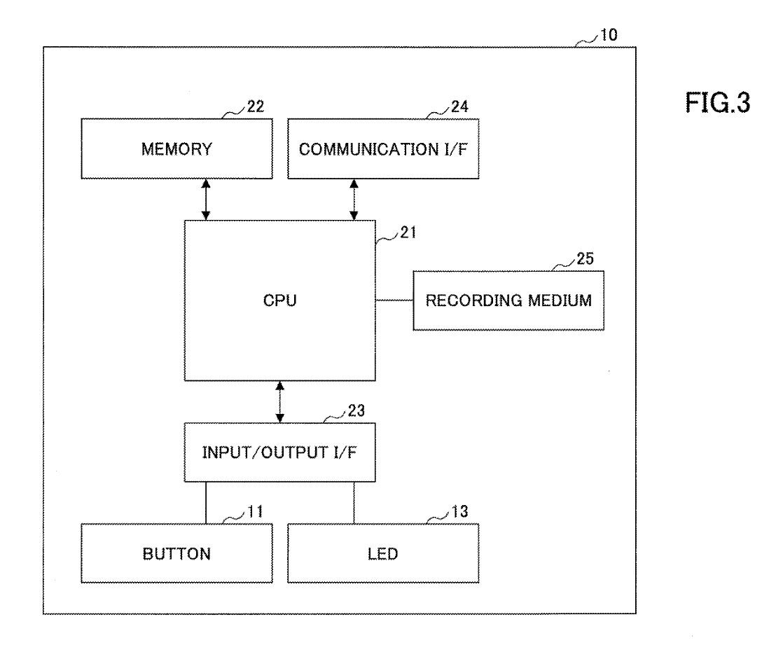

Next, an example of a hardware structure of the wearable device 10 according to the embodiment will be described with reference to FIG. 3. FIG. 3 is a diagram illustrating an example of a hardware structure of the wearable device 10 according to the embodiment. The wearable device 10 includes the button 11, the LED 13, a CPU 21, a memory 22, an input/output I/F 23, and a communication I/F 24.

The CPU 21 controls the wearable device 10 according to one or more programs stored in the memory 22. The memory 22 may be a semiconductor memory, for example. The memory 22 stores one or more programs including a login control processing program that the CPU 21 executes. Further, the memory 22 stores data that the CPU 21 refers to and data that represents results of processing executed by the CPU 21.

At least part of the data and the login control processing program may be stored in a recording medium 25 and may be copied to the memory as needed. Further, the obtained data may be copied to the recording medium 25 from the memory 22 as needed. The recording medium 25 may be realized by a non-volatile recording medium such as a flash memory, for example. In other words, the recording medium 25 may be a computer-readable recording medium storing the login control program for causing a computer such as the wearable device 10 to execute processing, which will be described later.

The input/output I/F 23 is an interface for receiving input of information from the user who holds (has) the wearable device 10 and for providing information to the user. For example, the input/output I/F 23 receives input of the information from an input device such as the button 11 and a touch panel. Further, the input/output I/F lights up or blinks the LED 13 to display (output) a warning to the user.

[Functional Structure of the Wearable Device 10]

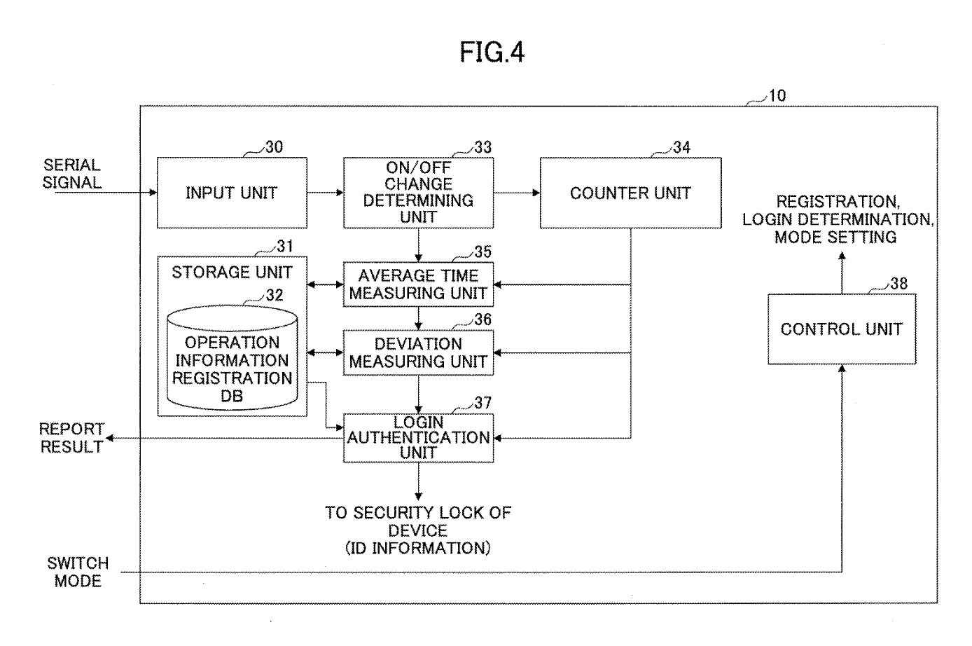

Next, an example of a functional structure of the wearable device 10 according to the embodiment will be described with reference to FIG. 4. FIG. 4 is a diagram illustrating an example of a functional structure of the wearable device according to the embodiment. The wearable device 10 includes functional blocks (elements) including an input unit 30, a storage unit 31, an ON/OFF change determining unit 33, a counter unit 34, an average time measuring unit 35, a deviation measuring unit 36, a login authentication unit 37, and a control unit 38.

According to the embodiment, the respective functional blocks (elements) are implemented by the login controlling circuit 12 provided inside of the wearable device 10. In this case, there are three types of a user interface (UI) between the wearable device 10 and the login controlling circuit 12, input of a serial signal, result notification of login authentication, and mode switching. Input of the serial signal and input of the mode switching signal are performed by the operation of the button 11 by the user. Further, a login authentication result is output to inside of the wearable device 10. In this way, locking the wearable device 10 or releasing the lock on the wearable device 10 is executed. For example, in a case where the login authentication is successful, the wearable device 10 is unlocked so that the user can start to use the wearable device 10. On the other hand, in a case where the login authentication is unsuccessful, the wearable device 10 is locked so that the user cannot use the wearable device 10.

The input unit 30 inputs a serial signal that corresponds to ON-operations and OFF-operations of the button 11 of the user. The ON/OFF change determining unit 33 determines (detects) that the signal changes from ON to OFF. Also, the ON/OFF change determining unit 33 determines (detects) that the signal changes from OFF to ON.

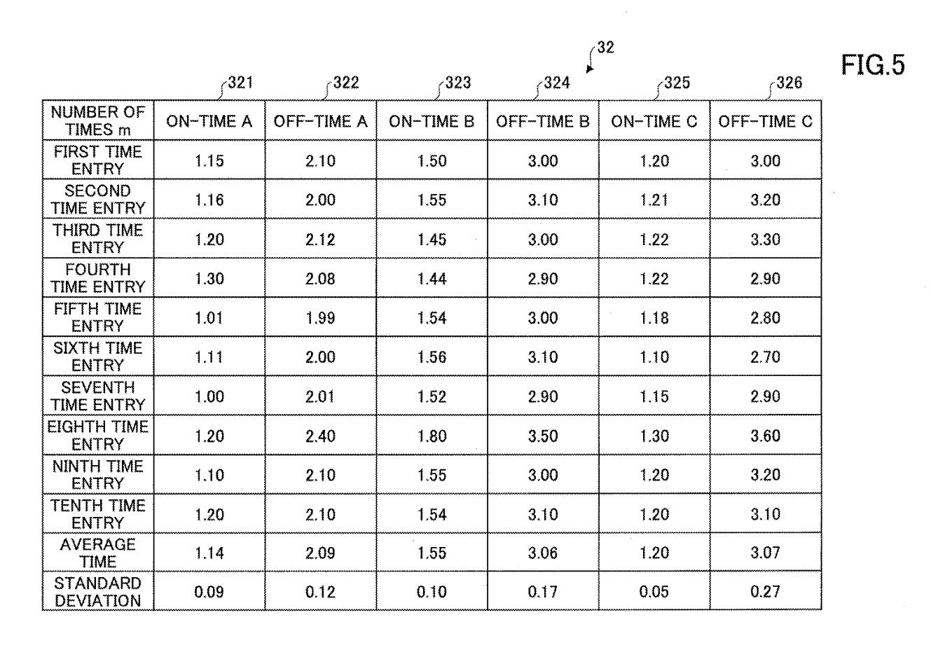

The storage unit 31 stores an operation information registration DB 32 and various kinds of information. FIG. 5 illustrates an example of the operation information registration DB 32. The operation information registration DB 32 stores, in accordance with ON-operations and OFF-operations of the button 11 at the time of registration, times of the respective ON-operations and times of the respective OFF-operations. The times (time spans) of the respective ON-operations may be referred to as respective ON-times, and the times (time spans) of the respective OFF-operations may be referred to as respective OFF-times. The operation information registration DB 32 stores average times (average time spans) for the respective ON-times, average times (average time spans) for the respective OFF-times, standard deviations for the average times for the respective ON-times, and standard deviations for the average times for the respective OFF-times. The average times are held (retained) in the operation information registration DB 32 as arrays such that time series or magnitude relationships are recognized. It should be noted that “the respective ON-times, the respective OFF-times, the average times for the respective ON-times, the average times for the respective OFF-times, the standard deviations for the respective ON-times, and the standard deviations for the respective OFF-times” registered in the operation information registration DB 32 is an example of registration information. The operation information registration DB 32 may store registration information for each user.

The example of FIG. 5 illustrates registration information of a case where a user performs ON-operations and OFF-operations with the button 11 to input a serial signal having a predetermined pattern in the same rhythmic pattern for 10 times at the time of registration. In FIG. 5, the values are in seconds [s]. As illustrated in the example of FIG. 5, ON-time A 321, OFF-time A 322, ON-time B 323, OFF-time B 324, ON-time C 325, and OFF-time C 326 are registered for each of the operation entries from first to tenth as performed by a specific user. Further, average times and standard deviations of the respective ON-times and the respective OFF-times from the first to tenth pattern entries are stored.

Referring back to FIG. 4, the counter unit counts the number of times of input (the number of input entries) of the registration information in accordance with the serial signal. The average time measuring unit 35 recounts the respective ON-times and the respective OFF-times every time the serial signal changes from ON to OFF or OFF to ON. The average time measuring unit 35 calculates the average times (average values) of the calculated respective ON-times and the average times (average values) of the calculated respective OFF-times.

The deviation measuring unit 36 calculates standard deviations of the respective ON-times and standard deviations of the respective OFF-times based on the measured respective ON-times, the average times of the respective ON-times, the measured respective OFF-times, the average times of the respective OFF-times, and the number of ON-operations and OFF-operations. In the example of FIG. 5, the average time from the first entry's ON-time A 321 (1.15) to the tenth entry's ON-time A 321 (1.20) is 1.14 s and the standard deviation from the first entry's ON-time A 321 to the tenth entry's ON-time A 321 is 0.09. According to examination by the present inventor, there is a tendency such that the longer the ON-time, the greater the standard deviation.

For example, the deviation measuring unit 36 calculates, based on the following formula (1), variance σ² to calculate a standard deviation.

$${σ}^{2} = \frac{1}{m} {\sum }_{n = 1}^{m} {( {x}_{n} - X )}^{2} \qquad ( 1 )$$

In formula (1), “m” represents the number of times (the number of pattern entries), “x” represents a respective ON-time or respective OFF-time, and “X” represents an average value of said respective ON-time or OFF-time. For example, for ON-time A 321, “m” is 10, “X” is 1.14, “x₁” is 1.15, “x₂” is 1.16 . . . and “x₁₀” is 1.20.

Next, the deviation measuring unit 36 calculates, based on the following formula (2), a standard deviation σ.

σ=\sqrt{σ²} (2)

According to the above described processing, as illustrated in FIG. 5, the order of the ON-times and the OFF-times, the number of times m of inputting the registration information, the respective ON-times, and the respective OFF-times are registered, in the operation information registration DB 32, in accordance with the changes of the signal from ON to OFF and OFF to ON. Further, the average times of the measured respective ON-times, the average times of the measured respective OFF-times, the standard deviations of the measured respective ON-times, and the standard deviations of the measured respective OFF-times are recorded in the operation information registration DB 32. It should be noted that average deviations may be recorded and used instead of the standard deviations.

Referring back to FIG. 4, the login authentication unit 37 determines, with reference to the average times of the respective ON-times, the average times of the respective OFF-times, the standard deviations of the respective ON-times, and the standard deviations of the respective OFF-times stored in the operation information registration DB 32, whether measured respective ON-operations and measured respective OFF-operations are performed within permissible ranges. For example, the login authentication unit 37 determines whether deviations between the measured respective ON-times and the stored average times for the respective ON-times are within ranges of the stored average times for the respective ON-times±the standard deviations. In other words, the authentication unit 37 may determine whether the deviations (differences) between the respective ON-times measured at the time of login and the average times stored at the time of registration are less than or equal to the respective stored standard deviations. Further, the login authentication unit 37 determines whether deviations between the respective measured OFF-times and the stored average times for the respective OFF-times are within ranges of the stored average times for the respective OFF-times±the standard deviations. In other words, the authentication unit may determine whether the deviations (differences) between the respective OFF-times measured at the time of login and the average times stored at the time of registration are less than or equal to the respective stored standard deviations. The login authentication unit 37 performs the login authentication based on a result of the determination. For example, in a case where the measured respective ON-times and the measured respective OFF-times are within the permissible ranges, the login authentication unit 37 permits the login.

The login authentication unit 37 notifies a user interface between the wearable device 10 and the login controlling circuit 12 of the determination result. The wearable device 10 is unlocked in a case where the login is successful as a result of the determination. The wearable device 10 is locked in a case where the login is unsuccessful as a result of the determination. The wearable device 10 to be locked can be specified by transmitting ID information on a device for which the lock and the releasing of the lock is controlled.

An example of a method for determining whether login is successful or not (unsuccessful) will be described. In the example of FIG. 5, the average time of the first ON-times A 321 is 1.14 s and the standard deviation of the first ON-times A 321 is 0.09, for example. Accordingly, the login authentication unit 37 determines that it is “OK” in a case where a first ON-time at the time of login operation is in a range of from 1.05 to 1.23 (1.14±0.09), and determines that it is “NG” in other cases. Similarly, the login authentication unit 37 determines whether it is “OK” or not (NG) for each of the other ON-times and OFF-times.

Referring back to FIG. 4, the control unit switches mode of login control between a registration mode and a login mode. During the registration mode, in accordance with operations performed by the user using the button 11, registration information including ON-times, OFF-times, and the like is registered in the operation information registration DB 32. Further, the operation information registration DB 32 may store a result of login determination. During the login mode, based on a serial signal that corresponds to ON-operations and OFF-operations performed by the user, it is determined whether to permit the login.

For example, the functional blocks (elements) of the ON/OFF change determining unit 33, the counter unit 34, the average time measuring unit 35, the deviation measuring unit 36, the login authentication unit 37, and the control unit 38 may be actualized by the hardware of the login controlling circuit 12. However, the embodiments are not limited to this. For example, the respective functional blocks may be realized by login control processing that one or more programs for the login control processing stored in the memory 22 cause the CPU 21 to execute or may be realized by a combination of hardware and software.

### First Embodiment

[Login Control Processing]

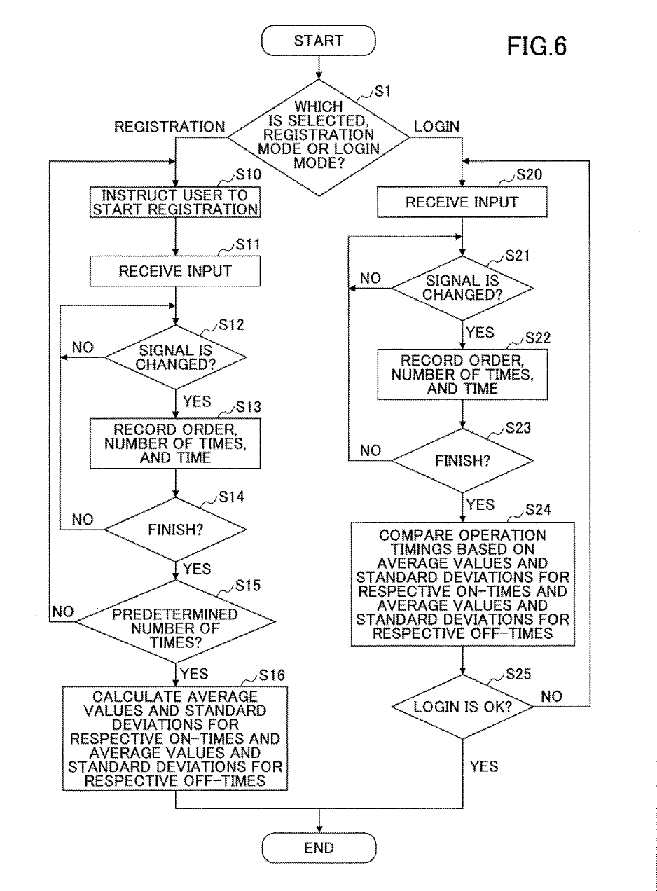

Next, login control processing according to a first embodiment will be described with reference to FIG. 6. FIG. 6 is a flowchart illustrating an example of the login control processing according to the first embodiment. When the processing is started, the control unit 38 determines in step S1 a mode based on a switching signal.

(Processing at the Time of Registration)

In a case where the user sets the wearable device 10 to be a registration state, the control unit 38 determines that the wearable device 10 is in the registration mode. Then, the control unit 38 instructs (prompts) the user to start to register a password in step S10.

In this case, the input unit 30 receives an input of a serial signal in step S11. Next, the ON/OFF change determining unit 33 determines (detects) a change of the serial signal from ON to OFF or OFF to ON in step S12. In a case where a change is present, the storage unit 31 stores, in the operation information registration DB 32, order of the ON-operations and the OFF-operations, the number of times of input, the respective ON-times, and the respective OFF-times in step S13. Next, the input unit 30 determines in step S14 whether the input of the serial signal is finished. Specifically, for example, when a predetermined time has passed from the start of inputting the serial signal or the input of the serial signal has reached an end of a signal pattern, the input unit 30 may determine that the input of the serial signal is finished.

In a case of determining that the input of the serial signal is not finished (NO in step S14), the processes in steps S12 to S14 are executed again. In a case of determining that the input of the serial signal is finished (YES in step S14), the input unit 30 determines whether the input has been performed for a predetermined number of times in step S15. In a case of determining that the input has not been performed for the predetermined number of times (NO in step S15), the input unit 30 receives the input of a next serial signal (steps S10 and S11) in accordance with instructions, and the processes in steps S10 to S15 are repeated until the input has been performed for the predetermined number of times.

In a case where the input unit 30 has determined that the input has been performed for the predetermined number of times (YES in step S15), the average time measuring unit 35 calculates in step S16 average times for the respective ON-times and average times for the respective OFF-times. In step S16 also, the deviation measuring unit 36 calculates standard deviations for the respective ON-times based on the average times for the respective ON-times and calculates standard deviations for the respective OFF-times based on the average times for the respective OFF-times. Thereby, processing in the registration mode is finished.

(Processing at the Time of Login)

In a case where the user sets the wearable device 10 to be in a login state in step S1, the control unit 38 determines that the wearable device is in the login mode. The user performs ON-operations and OFF-operations of the button 11 to input a serial signal (login operation). The input unit 30 receives the input of the serial signal in step S20. Next, the ON/OFF change determining unit determines (detects) a change of the serial signal from ON to OFF or OFF to ON in step S21. In a case where a change is present, the storage unit 31 stores, in the operation information registration DB 32, the order of the ON-operations and the OFF-operations, the number of times of input, the respective ON-times, and the respective OFF-times in step S22. Next, the input unit 30 determines in step S23 whether the input of the serial signal is finished. Specifically, for example, when a predetermined time has passed from the start of inputting the serial signal or the input of the serial signal has reached an end of a signal pattern, the input unit 30 determines that the input of the serial signal is finished.

In a case of determining that the input of the serial signal is not finished (NO in step S23), the processes in steps S21 to S23 are again executed. In a case where the input unit 30 has determined that the input of the serial signal is finished (YES in step S23), the login authentication unit 37 compares (determines) in step S24 whether the measured respective ON-times and the measured respective OFF-times of the current login operation are performed at timings within permissible ranges based on the average times and the standard deviations for the respective ON-times and the average times and the standard deviations for the respective OFF-times stored in the operation information registration DB 32.

That is, using the standard deviations calculated (acquired) as margins at the time of the registration mode, the login authentication unit 37 determines whether deviations of the measured respective ON-times and the measured respective OFF-times relative to the average values are within the permissible ranges.

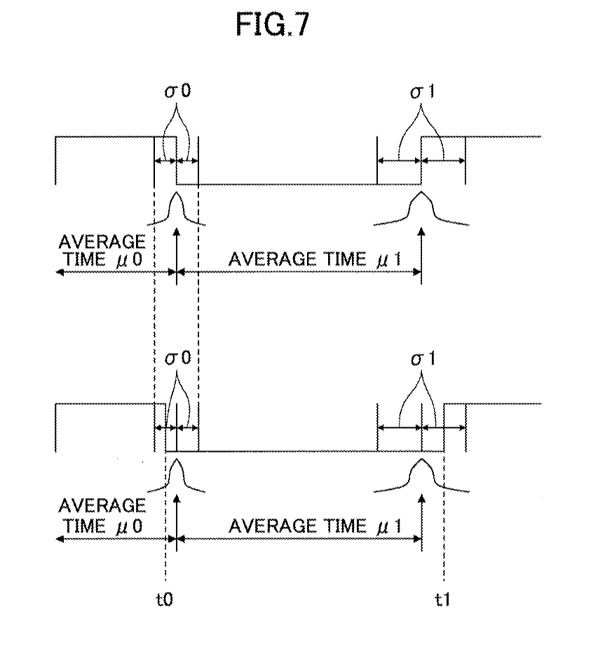

Specifically, for example, as illustrated in the upper part of FIG. 7, an average time of ON-times at the time of registration is μ0, a standard deviation of the ON-times at the time of registration is σ0, an average time of OFF-times at the time of registration is μ1, and a standard deviation of the OFF-times at the time of registration is σ1. As illustrated in the lower part of FIG. 7, at the time of measurement (at the time of login), an ON-operation is performed until time t0 and an OFF-operation is performed during a period from time t0 to time t1. In this case, when the input ON-operation time t0 is within a range of the average time μ0 of the ON-times at the time of registration±the standard deviation σ0, it is determined that the ON-operation at the time of measurement (in the login mode) is performed at a timing within the permissible range. Similarly, when the input OFF-operation time t1 is within a range of the average time μ1 of the OFF-times at the time of registration±the standard deviation σ1, it is determined that the OFF-operation at the time of measurement (in the login mode) is performed at a timing within the permissible range.

In FIG. 7, because time tO of the ON-operation is greater than the average time μ0—the standard deviation σ0 and less than the average time μ0, it is determined that the ON-operation is performed at a timing within the permissible range. Further, because time tl of the OFF-operation is greater than the average time μ1 and less than μ1+σ1, it is determined that the OFF-operation is performed at a timing within the permissible range.

Referring back to FIG. 6, when determining that timings of all of the ON-operations and the OFF-operations of the input serial signal are within the permissible ranges of the average values±the standard deviations for the ON-times and the OFF-times, the login authentication unit 37 permits the login in step S25.

As described above, according to the login control method of the first embodiment, the standard deviations, which represent deviations of the operation timings of when the registration information is input for a plurality of times, are calculated in accordance with the timings of the ON-operations and the OFF-operations of the button 11 performed by the user at the time of registration. Further, based on the standard deviations, the permissible ranges of the timings of the ON-operations and the OFF operations at the time of login operation are appropriately determined for each user. In this way, it becomes possible to perform login control in accordance with a login operation by a rhythmic pattern that is specific to each user and to perform login authentication appropriately. In this way, it becomes possible to learn identity (characteristics) of a user and to reinforce (enhance) the security.

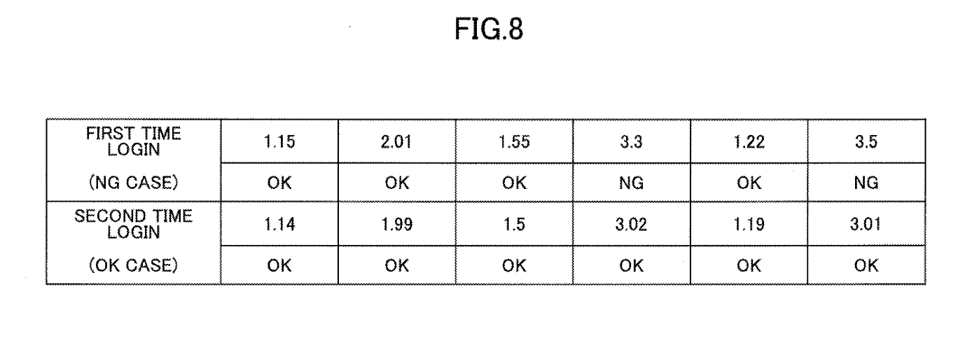

FIG. 8 illustrates an example of login authentication results of when login is tried twice. As illustrated in FIG. 8, the second OFF-time in the first time login is 3.3 s, the average time of the OFF times B324 at the time of registration illustrated in FIG. 5 is 3.06 s, and the standard deviation of the OFF times B324 is 0.17. Accordingly, because 3.3 is greater than 3.23 (3.3>3.06+0.17), the second OFF-time in the first login attempt is outside the range of the average time±the standard deviation of the corresponding OFF-time at the time of registration. In this way, if at least one of the ON-times and the OFF-times at the time of login is outside the range of the average time±the standard deviation of the corresponding ON-time or the corresponding OFF-time, the login is not permitted. On the other hand, because all of the ON-times and the OFF-times at the time of second login attempt are within the ranges of the average times±the standard deviations of the ON-times and the OFF times, the second login is permitted.

### Second Embodiment

[Login Control Processing]

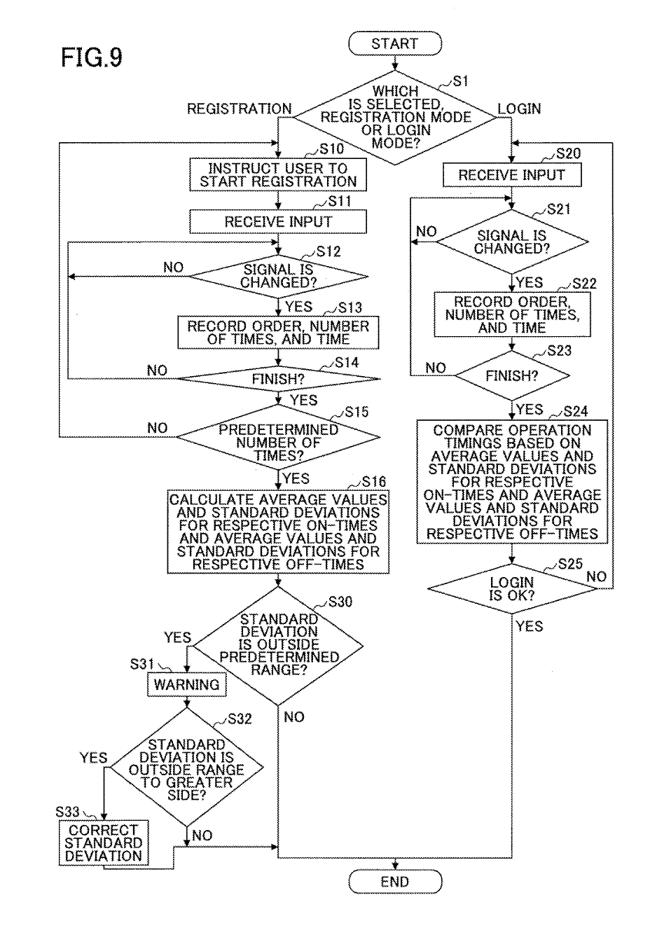

Next, login control processing according to a second embodiment will be described with reference to FIG. 9. FIG. 9 is a flowchart illustrating an example of the login control processing according to the second embodiment. When the processing is started, the control unit 38 determines in step S1 a mode based on a switching signal.

(Processing at the Time of Registration)

In a case of determining that the wearable device 10 is in the registration mode, the control unit 38 instructs (prompts) the user to start to register a password in step S10. Next, the input unit 30 receives an input of a serial signal in step S11. Next, the ON/OFF change determining unit 33 determines (detects) a change of the serial signal from ON to OFF or OFF to ON in step S12. In a case where a change is present, the storage unit 31 stores, in the operation information registration DB 32, the order of the ON-operations and the OFF-operations, the number of times of input, the respective ON-times, and the respective OFF-times in step S13.

Next, the input unit 30 determines in step S14 whether the input of the serial signal is finished. Specifically, for example, when a predetermined time has passed from the start of inputting the serial signal or the input of the serial signal has reached an end of a signal pattern, the input unit 30 may determine that the input of the serial signal is finished. In a case of determining that the input of the serial signal is not finished (NO in step S14), the processes in steps S12 to S14 are again executed.

In a case of determining that the input of the serial signal is finished (YES in step S14), the input unit 30 determines whether the input has been performed for a predetermined number of times in step S15. In a case of determining that the input has not been performed for the predetermined number of times (NO in step S15), the input unit 30 receives the input of a next serial signal (steps S10 and S11) in accordance with instructions, and the processes in steps S10 to S15 are repeated until the input is performed for the predetermined number of times.

In a case where the input unit 30 has determined that the input has been performed for the predetermined number of times (YES in step S15), the average time measuring unit 35 calculates in step S16 average times for the respective ON-times and average times for the respective OFF-times. In step S16 also, the deviation measuring unit 36 calculates standard deviations for the respective ON-times based on the average times for the respective ON-times and calculates standard deviations for the respective OFF-times based on the average times for the respective OFF-times.

Next, the login authentication unit 37 determines whether the respective standard deviations registered in the operation information registration DB 32 are outside predetermined ranges in step S30. If the standard deviations are within the predetermined ranges (NO in step S30), the processing ends.

If at least one of the standard deviations registered in the operation information registration DB 32 is outside the predetermined range (YES in step S30), using a result-notifying mechanism, the login authentication unit 37 notifies the user of a warning in step S31. Next, the login authentication unit 37 determines whether the standard deviation is outside the range to a greater side in step S32. In other words, the login authentication unit 37 determines whether the standard deviation is greater than an upper limit value of the predetermined range. In a case where the standard deviation is outside the range to the greater side (YES in step S32), the login authentication unit 37 replaces the standard deviation with a predetermined value, which may be the upper limit value of the predetermined range, to correct the standard deviation in step S33. The login authentication unit 37 may replace the standard deviation with the predetermined value not only in a case where the standard deviation is outside the range to the greater side but also in a case where the standard deviation is outside the range to the smaller side. Thereby, with reference to the operation information registration DB 32, which corrects at least one standard deviation outside the predetermined range to the predetermined value and stores the predetermined value, the login authentication unit 37 may determine whether the measured respective ON-times and the measured respective OFF-times are within the permissible ranges.

(Processing at the Time of Login)

Because processes in steps S20 to S25 according to the second embodiment are equal to the processes in steps S20 to S25 according to the first embodiment, their description are omitted here.

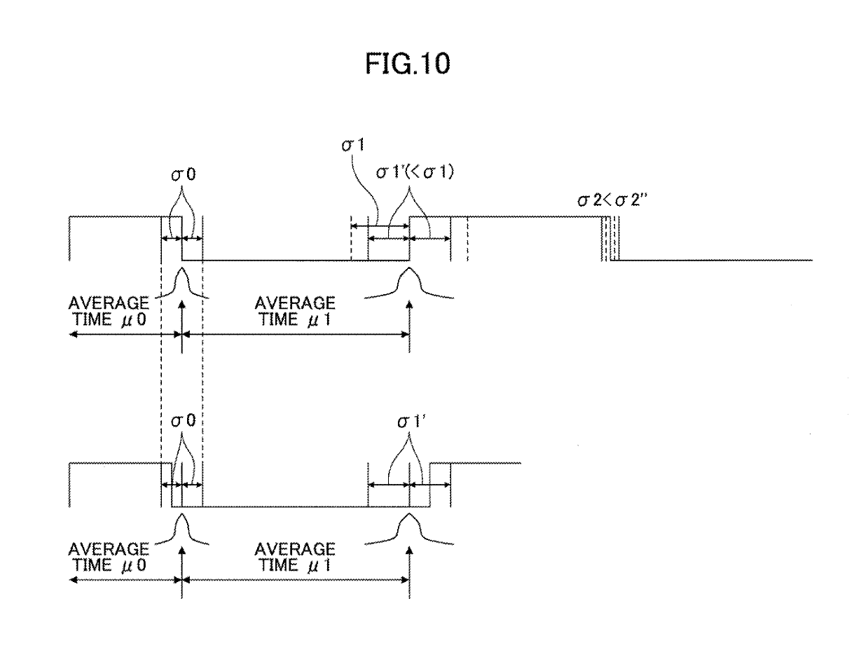

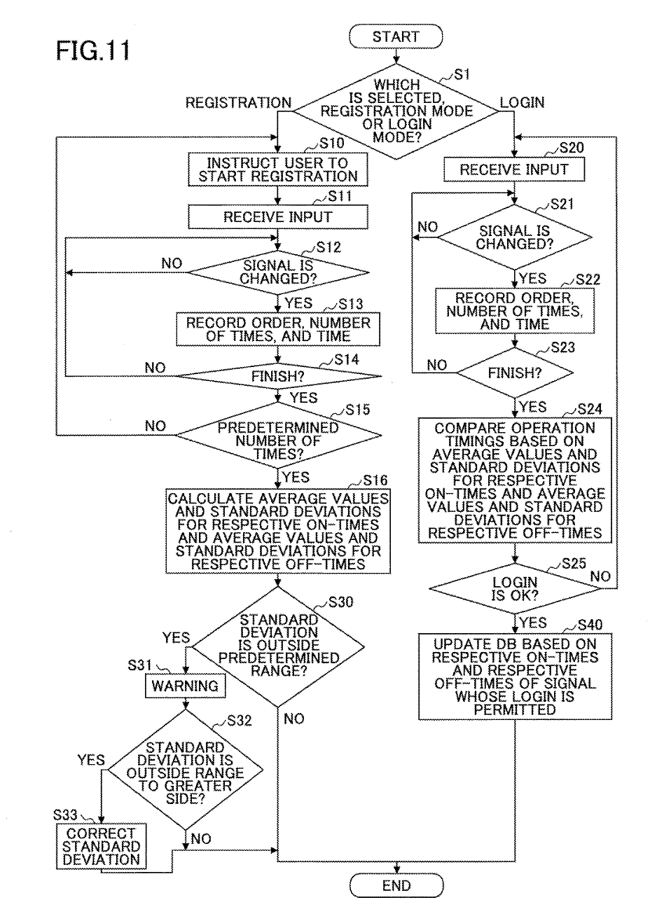

FIG. 10 is a diagram illustrating a login control operation according to the second embodiment. An upper part of FIG. 10 illustrates average time μ0, average time pl, standard deviation σ0 and standard deviation σ1 at the time of registration. A lower part of FIG. 10 illustrates an operation at the time of measurement (login). As described above, according to the login control method of the second embodiment, as illustrated in FIG. 10, in a case where the standard deviation σ1 stored in the operation information registration DB 32 is greater than the predetermined value σ1′, the standard deviation σ1 is replaced with the predetermined value σ1′. In this way, accuracy of the login authentication can be enhanced. Even in a case where the standard deviation registered in the operation information registration DB 32 is less than a predetermined value, the standard deviation may be replaced with the predetermined value.

### Third Embodiment

[Login Control Processing]

Next, login control processing according to a third embodiment will be described with reference to FIG. 11. FIG. 11 is a flowchart illustrating an example of the login control processing according to the third embodiment. The login control processing according to the third embodiment is different from the login control processing according to the second embodiment (see FIG. 9) in that, when the login is successful (YES in step S25), there is a process (step S40) for updating the operation information registration DB 32, which is performed based on the registration information (the respective ON-times and the respective OFF-times) corresponding to the serial signal that is successful in the login.

In a case where the login is permitted, the storage unit 31 may delete the oldest information or registration information having information most deviated from the average value(s) among the arrays of the registration information recorded m times in the operation information registration DB 32. Then, the storage unit 31 may record, in the deleted location, the registration information on the serial signal that is successful in the current login. In other words, the storage unit 31 may store the respective ON-times and the respective OFF-times of the serial signal of when the login is permitted. Then, the storage unit 31 may recalculate the average times and the standard deviations for the respective ON-times and the respective OFF-times to update the operation information registration DB 32 after deleting respective ON-times and respective OFF-times of an oldest stored serial signal from the operation information registration DB 32. At this time, the storage unit 31 may alternatively delete a serial signal having a value that is most deviated from an average value. The serial signal to be deleted may be selected from the serial signals stored in the operation information registration DB 32. Note that when storing, in the operation information registration DB 32, the registration information on the serial signal that is successful in a current login, it is not necessary to delete other registration information until a predetermined number of registration information (serial signal) is stored in the operation information registration DB 32.

### Fourth Embodiment

[Login Control Processing]

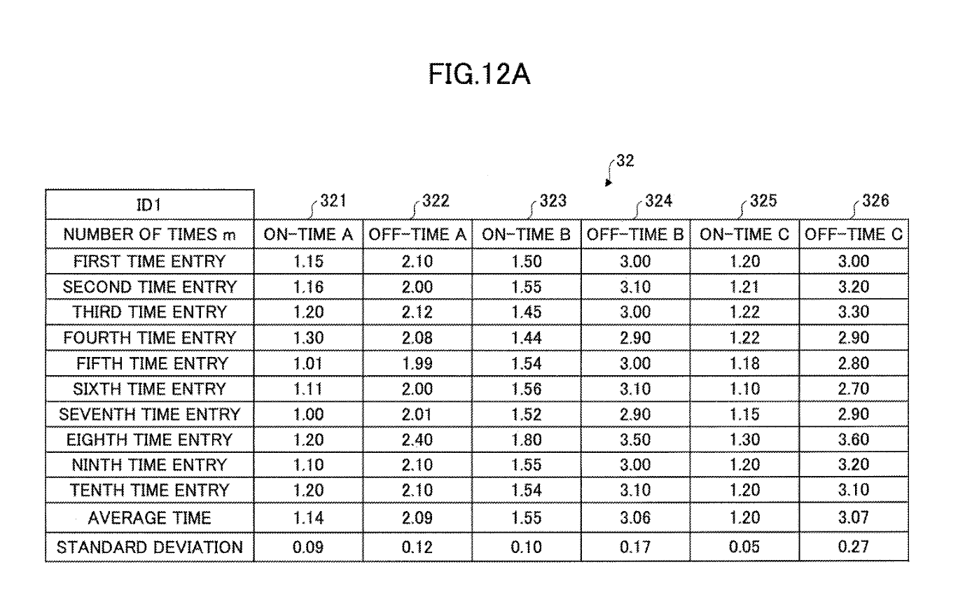

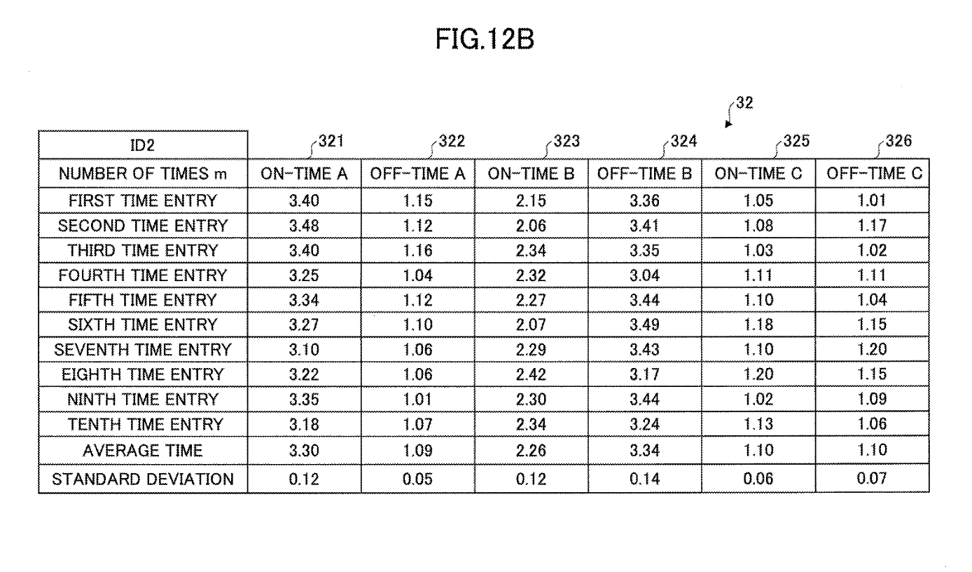

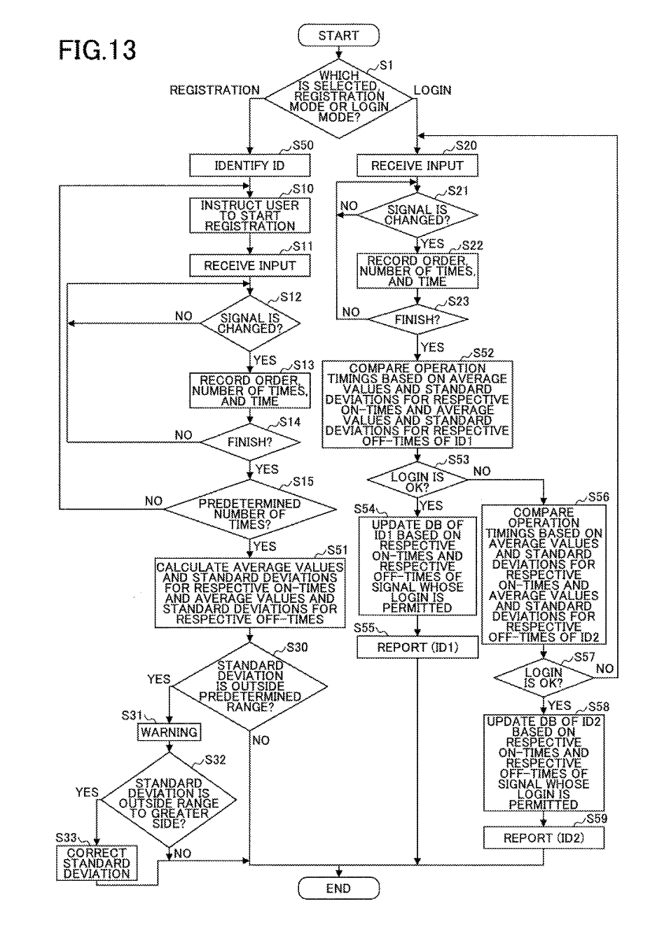

Next, login control processing according to a fourth embodiment will be described with reference to FIGS. 12A and 12B and 13. FIGS. 12A and 12B illustrate an example of the operation information registration DB 32 according to the fourth embodiment. FIG. 13 is a flowchart illustrating an example of the login control processing according to the fourth embodiment.

According to the fourth embodiment, a plurality of sets of registration information, which are references, are stored in the operation information registration DB 32. Then, each set of registration information is identified by a login ID. Thereby, it becomes possible to identify the login ID at the same time only by inputting a password. FIG. 12A illustrates registration information for ID1, which is a login ID. As illustrated in FIG. 12A, the operation information registration DB 32 stores, for the ID1, the first to tenth operations (entries), average times, and standard deviations. FIG. 12B illustrates registration information for ID2, which is a login ID. As illustrated in FIG. 12B, the operation information registration DB 32 stores, for the ID2, the first to the tenth operations (entries), average times, and standard deviations.

In the login control processing according to the fourth embodiment illustrated in FIG. 13, when the processing is started, the control unit 38 determines in step S1 a mode based on a switching signal.

(Processing at the Time of Registration)

When determining that the wearable device 10 is in the registration mode, the control unit 38 obtains a login ID, which is an example of ID identification information, from the operation information registration DB 32 in step S50, and instructs (prompts) the user to start to register a password in step S10. Next, the input unit 30 receives an input of a serial signal in step S11. Next, the ON/OFF change determining unit 33 determines (detects) a change of the serial signal from ON to OFF or OFF to ON in step S12.

Next, the storage unit 31 stores, in the operation information registration DB 32, the order of the ON-operations and the OFF-operations, the number of times of input, the respective ON-times, and the respective OFF-times in step S13.

Next, the input unit 30 determines in step S14 whether the input of the serial signal is finished. Specifically, for example, when a predetermined time has passed from the start of inputting the serial signal or the input of the serial signal has reached an end of a signal pattern, the input unit 30 may determine that the input of the serial signal is finished. In a case of determining that the input of the serial signal is not finished (NO in step S14), the processes in steps S12 to S14 are executed again.

In a case of determining that the input of the serial signal is finished (YES in step S14), the input unit 30 determines whether the input has been performed for a predetermined number of times in step S15. In a case of determining that the input has not been performed for the predetermined number of times (NO in step S15), the input unit 30 receives the input of a next serial signal (steps S10 and S11) in accordance with instructions, and the processes in steps S10 to S15 are repeated until the input has been performed for the predetermined number of times.

In a case where the input unit 30 has determined that the input has been performed for the predetermined number of times (YES in step S15), the average time measuring unit 35 calculates in step S51 average times for the respective ON-times of the obtained login ID and average times for the respective OFF-times of the obtained login ID. In step S51 also, the deviation measuring unit 36 calculates standard deviations for the respective ON-times based on the average times for the respective ON-times and calculates standard deviations for the respective OFF-times based on the average times for the respective OFF-times. Next, the login authentication unit 37 determines whether the respective standard deviations registered in the operation information registration DB 32 are outside predetermined ranges in step S30. If the standard deviations are within the predetermined ranges (NO in step S30), the processing ends. If at least one of the standard deviations registered in the operation information registration DB 32 is outside the predetermined range (YES in step S30), using a result-notifying mechanism, the login authentication unit 37 notifies the user of a warning in step S31. Next, the login authentication unit 37 determines whether the standard deviation is outside the range to a greater side in step S32. In other words, the login authentication unit 37 determines whether the standard deviation is greater than an upper limit value of the predetermined range. In a case where the standard deviation is outside the range to the greater side (YES in step S32), the login authentication unit 37 replaces the standard deviation with a predetermined value to correct the standard deviation in step S33.

(Processing at the Time of Login)

In a case of determining in step S1 that the wearable device 10 is in the login mode, the input unit 30 receives the input of the serial signal in step S20. Next, the ON/OFF change determining unit 33 determines (detects) a change of the serial signal from ON to OFF or OFF to ON in step S21. Next, the storage unit 31 registers, in the operation information registration DB 32, order of the counted operations, the number of times of input, the respective ON-times, and the respective OFF-times in step S22.

Next, the input unit 30 determines in step S23 whether the input of the serial signal is finished. Specifically, for example, when a predetermined time has passed from the start of inputting the serial signal or the input of the serial signal has reached an end of a signal pattern, the input unit 30 determines that the input of the serial signal is finished. In a case of determining that the input of the serial signal is not finished (NO in step S23), the processes in steps S21 to S23 are executed again. In a case where the input unit has determined that the input of the serial signal is finished (YES in step S23), the login authentication unit 37 compares (determines) in step S52 whether the timings of the measured respective ON-times and the measured respective OFF-times are in the permissible ranges based on the average times of the ON-times, the average times of the OFF-times, and the standard deviations for the registration information of ID1. That is, the login authentication unit 37 determines whether the timings of all of the ON-operations and the OFF-operations of the input serial signal are within the permissible ranges of the registration information of ID1, which are ranges of the average values of the ON-times and the OFF-times±the standard deviations.

When determining that the timings of all of the input ON-operations and the input OFF-operations are within the permissible ranges of the registration information of ID1, which are ranges of the average values of the ON-times and the OFF-times±the standard deviations, the login authentication unit 37 permits the login in step S53.

At the time of permitting the login, the storage unit 31 allocates (gives) ID1 as a login ID and registers, in the operation information registration DB 32 in association with the login ID in step S54, the registration information of when the login is permitted. Further, at the time of permitting the login, the control unit 38 notifies the user in step S55 of the login ID (ID1) for the registration information whose login is permitted.

In a case of determining not to permit the login (NO in step S53), the login authentication unit 37 determines in step S56 whether the timings of all of the ON-operations and the OFF-operations are within permissible ranges of the registration information of ID2, which are ranges of the average values of the ON-times and the OFF-times±the standard deviations. In a case of determining that the timings are outside the ranges, the process flow returns to step S20. In other words, in a case where at least one timing is outside of the permissible range, the process flow may return to step S20. Then, the input unit 30 receives the input of a next serial signal in step S20 and processing subsequent to step S20 is repeated.

On the other hand, in a case of determining that the timings are within the permissible ranges of the registration information of ID2, which are ranges of the average values of the ON-times and the OFF-times±the standard deviations, the login authentication unit 37 permits the login in step S57. Next, the storage unit 31 allocates (gives) the ID2 as a login ID and registers, in the operation information registration DB 32 in association with the login ID (ID2) in step S58, the registration information of when the login is permitted. Further, at the time of permitting the login, the control unit 38 notifies the user in step S59 of the login ID (ID2) for the registration information whose login is permitted.

As described, according to the login control method of the fourth embodiment, the operation information registration DB 32 stores a plurality of sets of the standard deviations for the registered respective ON-times and the registered respective OFF-times in association with the login IDs. In other words, the operation information registration DB 32 may store, in association with ID identification information for each user, respective ON-times, respective OFF-times, average times, and standard deviations. Then, the operation information registration DB 32 is referred to to determine whether the measured respective ON-times and the measured respective OFF-times of the input serial signal are within the permissible ranges. In accordance with a result of the determination, it is possible to specify a login ID of which the login is permitted.

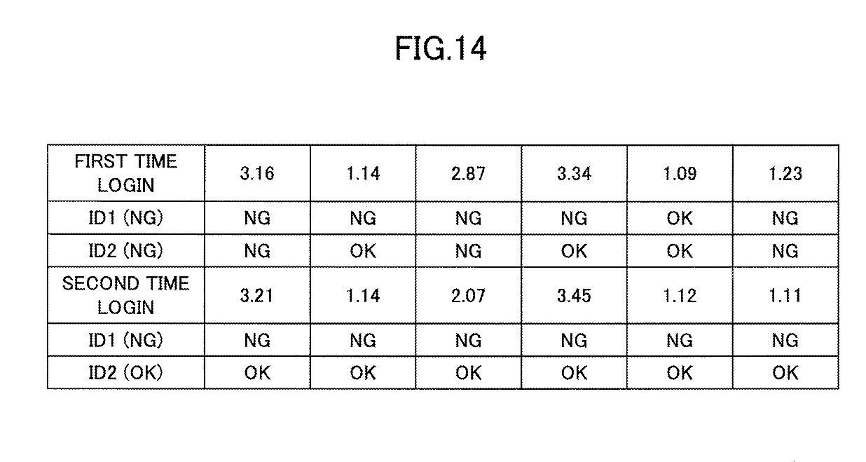

FIG. 14 illustrates an example of results of the login control processing according to the fourth embodiment. In the example of FIG. 14, the login control processing is performed on the serial signal of a first-time login operation based on the registration information for ID1. As a result, the login is not permitted. Next, the login control processing is performed on the same serial signal based on the registration information for ID2. As a result, the login is not permitted.

Next, the login control processing is performed on the serial signal of a second-time login operation based on the registration information for ID1. As a result, the login is not permitted. Next, the login control processing is performed on the same serial signal based on the registration information for ID2. As a result, the login is permitted.

As described above, according to the login control processing of the first to fourth embodiments, it becomes possible to perform the login control in accordance with the rhythm of the login operation of each user.

It should be noted that information stored in the operation information registration DB 32 may be stored in a server or the like on a cloud that is connected to the wearable device 10 via a network or in the memory 22.

The login control method, the login control apparatus, and the program stored in the computer-readable recording medium are described above with reference to the embodiments. However, the login control method, the login control apparatus, and the program according to the present invention are not limited to the above described embodiments and various variations and modifications may be made without departing from the spirit and scope of the present invention. Further, the embodiments, and a variation example may be combined as long as a contradiction does not occur.

It should be noted that the above described apparatus according to the embodiments may be realized by a device memory, which stores at least one program, and by at least one processor (computer), which executes the at least one program to execute processing as described in the embodiments. In other words, the wearable device 10 may be realized by the device memory and the at least one processor, for example. For example, the device memory and the at least one processor can implement functions as described in the embodiments and may be implemented by hardware elements as described in the embodiments. The at least one program for causing a computer to execute processing as described above may be stored in a computer-readable recording medium.

All examples and conditional language provided herein are intended for the pedagogical purposes of aiding the reader in understanding the invention and the concepts contributed by the inventors to further the art, and are not to be construed as limitation to such specifically recited examples and conditions, nor does the organization of such examples in the specification relate to a showing of superiority and inferiority of the invention. Although one or more embodiments of the present invention have been described in detail, it should be understood that the various changes, substitutions, and alterations could be made hereto without departing from the spirit and scope of the invention.

What is claimed is:

1. A login control method executed by a computer, the login control method comprising:
inputting a serial signal that corresponds to ON-operations and OFF-operations;
measuring respective ON-times of the ON-operations and respective OFF-times of the OFF-operations of the input serial signal;
referring to a storage unit, which stores average times for the respective ON-times, deviations for the respective ON-times, average times for the respective OFF-times, and deviations for the respective OFF-times, to determine whether the measured respective ON-times and the measured respective OFF-times are within permissible ranges; and
permitting login in a case where the measured respective ON-times and the measured respective OFF-times are within the permissible ranges.

2. The login control method according to claim 1, wherein, in a case where at least one of the deviations for the respective ON-times and the deviations for the respective OFF-times stored in the storage unit is outside a predetermined range, the storage unit, which corrects the at least one of the deviations that is outside the predetermined range to a predetermined value and stores the predetermined value, is referred to to determine whether the measured respective ON-times and the measured respective OFF-times are within the permissible ranges.

3. The login control method according to claim 2, further comprising:
outputting a warning in the case where the at least one of the deviations for the respective ON-times and the deviations for the respective OFF-times stored in the storage unit is outside the predetermined range.

4. The login control method according to claim 1,
wherein the storage unit, which stores average times for the respective ON-times, deviations for the respective ON-times, average times for the respective OFF-times, and deviations for the respective OFF-times in association with ID identification information for each user, is referred to to determine whether the measured respective ON-times and the measured respective OFF-times are within permissible ranges, and
wherein ID identification information of which login is permitted is specified based on a result of the determination.

5. The login control method according to claim 1, further comprising:
registering, in the storage unit, the respective ON-times and the respective OFF-times of the serial signal of when the login is permitted; and
recalculating the average times for the respective ON-times, the deviations for the respective ON-times, the average times for the respective OFF-times, and the deviations for the respective OFF-times to update the storage unit after deleting respective ON-times and respective OFF-times of an oldest stored serial signal from the storage unit.

6. The login control method according to claim 1, further comprising:
registering, in the storage unit, the respective ON-times and the respective OFF-times of the serial signal of when the login is permitted; and
recalculating the average times for the respective ON-times, the deviations for the respective ON-times, the average times for the respective OFF-times, and the deviations for the respective OFF-times to update the storage unit after deleting, from the storage unit, respective ON-times and respective OFF-times of a serial signal that is most deviated from an average value.

7. A login control apparatus comprising:
a processor configured to execute processing, the processing comprising:
inputting a serial signal that corresponds to ON-operations and OFF-operations;
measuring respective ON-times of the ON-operations and respective OFF-times of the OFF-operations of the input serial signal;
referring to a storage unit, which stores average times for the respective ON-times, deviations for the respective ON-times, average times for the respective OFF-times, and deviations for the respective OFF-times, to determine whether the measured respective ON-times and the measured respective OFF-times are within permissible ranges; and
permitting login in a case where the measured respective ON-times and the measured respective OFF-times are within the permissible ranges.

8. The login control apparatus according to claim 7, wherein, in a case where at least one of the deviations for the respective ON-times and the deviations for the respective OFF-times stored in the storage unit is outside a predetermined range, the storage unit, which corrects the at least one of the deviations that is outside the predetermined range to a predetermined value and stores the predetermined value, is referred to to determine whether the measured respective ON-times and the measured respective OFF-times are within the permissible ranges.

9. The login control apparatus according to claim 8, the processing further comprising:
outputting a warning in the case where the at least one of the deviations for the respective ON-times and the deviations for the respective OFF-times stored in the storage unit is outside the predetermined range.

10. The login control apparatus according to claim 7,
wherein the storage unit, which stores average times for the respective ON-times, deviations for the respective ON-times, average times for the respective OFF-times, and deviations for the respective OFF-times in association with ID identification information for each user, is referred to to determine whether the measured respective ON-times and the measured respective OFF-times are within permissible ranges, and
wherein ID identification information of which login is permitted is specified based on a result of the determination.

11. The login control apparatus according to claim 7, the processing further comprising:
registering, in the storage unit, the respective ON-times and the respective OFF-times of the serial signal of when the login is permitted; and
recalculating the average times for the respective ON-times, the deviations for the respective ON-times, the average times for the respective OFF-times, and the deviations for the respective OFF-times to update the storage unit after deleting respective ON-times and respective OFF-times of an oldest stored serial signal from the storage unit.

12. The login control apparatus according to claim 7, the processing further comprising:
registering, in the storage unit, the respective ON-times and the respective OFF-times of the serial signal of when the login is permitted; and
recalculating the average times for the respective ON-times, the deviations for the respective ON-times, the average times for the respective OFF-times, and the deviations for the respective OFF-times to update the storage unit after deleting, from the storage unit, respective ON-times and respective OFF-times of a serial signal that is most deviated from an average value.

13. A computer-readable recording medium having stored therein a program for causing a computer to execute processing, the processing comprising:
inputting a serial signal that corresponds to ON-operations and OFF-operations;
measuring respective ON-times of the ON-operations and respective OFF-times of the OFF-operations of the input serial signal;
referring to a storage unit, which stores average times for the respective ON-times, deviations for the respective ON-times, average times for the respective OFF-times, and deviations for the respective OFF-times, to determine whether the measured respective ON-times and the measured respective OFF-times are within permissible ranges; and
permitting login in a case where the measured respective ON-times and the measured respective OFF-times are within the permissible ranges.

14. The computer-readable recording medium according to claim 13, wherein, in a case where at least one of the deviations for the respective ON-times and the deviations for the respective OFF-times stored in the storage unit is outside a predetermined range, the storage unit, which corrects the at least one of the deviations that is outside the predetermined range to a predetermined value and stores the predetermined value, is referred to to determine whether the measured respective ON-times and the measured respective OFF-times are within the permissible ranges.

15. The computer-readable recording medium according to claim 14, the processing further comprising:
outputting a warning in the case where the at least one of the deviations for the respective ON-times and the deviations for the respective OFF-times stored in the storage unit is outside the predetermined range.

16. The computer-readable recording medium according to claim 13,
wherein the storage unit, which stores average times for the respective ON-times, deviations for the respective ON-times, average times for the respective OFF-times, and deviations for the respective OFF-times in association with ID identification information for each user, is referred to to determine whether the measured respective ON-times and the measured respective OFF-times are within permissible ranges, and
wherein ID identification information of which login is permitted is specified based on a result of the determination.

17. The computer-readable recording medium according to claim 13, the processing further comprising:
registering, in the storage unit, the respective ON-times and the respective OFF-times of the serial signal of when the login is permitted; and
recalculating the average times for the respective ON-times, the deviations for the respective ON-times, the average times for the respective OFF-times, and the deviations for the respective OFF-times to update the storage unit after deleting respective ON-times and respective OFF-times of an oldest stored serial signal from the storage unit.

18. The computer-readable recording medium according to claim 13, the processing further comprising:
registering, in the storage unit, the respective ON-times and the respective OFF-times of the serial signal of when the login is permitted; and
recalculating the average times for the respective ON-times, the deviations for the respective ON-times, the average times for the respective OFF-times, and the deviations for the respective OFF-times to update the storage unit after deleting, from the storage unit, respective ON-times and respective OFF-times of a serial signal that is most deviated from an average value.
